(19) United States
(12) Patent Application Publication
(10) Pub. No.: US 2013/0112914 A1
(43) Pub. Date: May 9, 2013

(54) Slurry Composition For Polishing And Method Of Manufacturing Phase Change Memory Device Using The Same

(71) Applicants: Choong-Ho HAN, Seoul (KR); Sang-Kyun KIM, Yongin-si (KR); Ye-Hwan KIM, Seoul (KR); Joon-Sang PARK, Seoul (KR); Jin-Woo BAE, Yongin-si (KR); Won-Jun LEE, Seoul (KR); Kyoung-Moon KANG, Gwangmyeong-si (KR); Jae-Dong LEE, Seongnam-si (KR)

(72) Inventors: Choong-Ho HAN, Seoul (KR); Sang-Kyun KIM, Yongin-si (KR); Ye-Hwan KIM, Seoul (KR); Joon-Sang PARK, Seoul (KR); Jin-Woo BAE, Yongin-si (KR); Won-Jun LEE, Seoul (KR); Kyoung-Moon KANG, Gwangmyeong-si (KR); Jae-Dong LEE, Seongnam-si (KR)

(73) Assignee: SAMSUNG ELECTRONICS CO., LTD., Suwon-si (KR)

(21) Appl. No.: 13/617,160

(22) Filed: Sep. 14, 2012

(30) Foreign Application Priority Data
Nov. 4, 2011 (KR) 10-2011-0114629

(51) Int. Cl. C09K 13/00

(52) U.S. Cl. 252/79.1

(57) ABSTRACT

A slurry composition includes an abrasive agent, an oxidizing agent, and a first adsorption inhibitor including a polyethylene oxide copolymer. A method of manufacturing a phase change memory device may include providing a substrate including an interlayer insulating film having a trench and a phase change material layer on the interlayer insulating film filling the trench, and performing chemical mechanical polishing on the phase change material layer using the slurry composition to form a phase change material pattern layer.

### CROSS-REFERENCE TO RELATED APPLICATION

This application claims priority from Korean Patent Application No. 10-2011-0114629 filed on Nov. 4, 2011 in the Korean Intellectual Property Office, and all the benefits accruing therefrom under 35 U.S.C. 119, the contents of which in its entirety are herein incorporated by reference.

### BACKGROUND

1. Field

Example embodiments relate to a slurry composition for polishing and/or a method of manufacturing a phase change memory device using the same.

2. Description of the Related Art

Recently, with rapid increase in the use of a digital camera, camcorder, MP3, DMB, navigator and mobile phone, there is an increasing demand for a semiconductor memory. Accordingly, many efforts are being made to develop a next-generation memory adopting advantages of existing dynamic random access memory (DRAM), static RAM (SRAM) and flash memory. As examples of the next-generation memory, there is a phase change random access memory (PRAM), resistive RAM (RRAM), magnetic RAM (MRAM) and/or polymer memory.

The phase change memory device (PRAM) stores data using a state change of a phase change material, e.g., chalcogenide alloy. The phase change material is changed into a crystalline state or amorphous state while being cooled after being heated. The phase change material in a crystalline state has a lower resistance and the phase change material in an amorphous state has a higher resistance. Accordingly, the crystalline state may be defined as set data or 0 data, and the amorphous state may be defined as reset data or 1 data.

In a method of manufacturing a phase change memory device, a phase change material pattern layer storing data may be formed by depositing a phase change material layer in a film deposition process and then dry etching the phase change material layer. However, the phase change material layer may be damaged in dry etching and an error in data storage may occur in the damaged portion. In order to prevent or inhibit such error, a method of forming a phase change material pattern layer using a damascene process or self-aligned process has been developed and the damascene process or self-aligned process is accompanied with a polishing process of the phase change material layer.

Meanwhile, in a process of polishing the phase change material layer to form the phase change material pattern layer, the phase change material removed by polishing is re-adsorbed onto the phase change material pattern layer to cause a defect on the phase change material pattern layer, thereby disturbing an operation of the phase change memory device.

### SUMMARY

Example embodiments provide a slurry composition for polishing capable of preventing or inhibiting a removed phase change material from being re-adsorbed onto a phase change material layer while maintaining a removal rate in a polishing process of the phase change material layer, thereby improving a performance of a phase change memory device.

Example embodiments also provide a method of manufacturing a phase change memory device with an improved performance by preventing or inhibiting a removed phase change material from being re-adsorbed onto a phase change material layer in a polishing process of the phase change material layer.

### BRIEF DESCRIPTION OF THE DRAWINGS

The above and other aspects and features of the inventive concepts will become more apparent by describing in detail example embodiments thereof with reference to the attached drawings, in which:

FIG. 1 schematically shows an interaction between a slurry composition for polishing and a phase change material when there is no adsorption inhibitor;

FIG. 2 schematically shows an interaction between a phase change material and a first adsorption inhibitor included in a slurry composition for polishing in accordance with example embodiments;

FIG. 3 schematically shows an interaction between first and second adsorption inhibitors and a phase change material included in a slurry composition for polishing in accordance with example embodiments;

FIGS. 4 to 6 are cross-sectional views showing intermediate structures for explaining a method of manufacturing a phase change memory device in accordance with example embodiments;

FIGS. 7 to 15 are cross-sectional views showing intermediate structures for explaining a method of manufacturing a phase change memory device in accordance with example embodiments;

FIG. 16 is a graph showing a relationship between degree of ionization and pH when there is complexation between the first adsorption inhibitor and the second adsorption inhibitor;

FIG. 17 is a graph showing a removal rate of the slurry composition for polishing;

FIG. 18 illustrates defects measured after the phase change material layer is polished using the slurry composition for polishing; and

FIGS. 19 to 23 schematically show systems using a phase change memory device manufactured by the method in accordance with example embodiments.

### DETAILED DESCRIPTION OF THE EMBODIMENTS

The inventive concepts will now be described more fully hereinafter with reference to the accompanying drawings, in which example embodiments are shown. The inventive concepts may, however, be embodied in different forms and should not be construed as limited to example embodiments set forth herein. Rather, these embodiments are provided so that this disclosure will be thorough and complete, and will fully convey the scope of the inventive concepts to those skilled in the art. The same reference numbers indicate the same components throughout the specification. In the attached figures, the thickness of layers and regions is exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the inventive concepts (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted.

Unless defined otherwise, all technical and scientific terms used herein have the same meaning as commonly understood by one of ordinary skill in the art to which the inventive concepts belong. It is noted that the use of any and all examples, or example terms provided herein is intended merely to better illuminate the inventive concepts and is not a limitation on the scope of the inventive concepts unless otherwise specified. Further, unless defined otherwise, all terms defined in generally used dictionaries may not be overly interpreted.

The inventive concepts will be described with reference to perspective views, cross-sectional views, and/or plan views, in which example embodiments are shown. Thus, the profile of an example view may be modified according to manufacturing techniques and/or allowances. That is, example embodiments are not intended to limit the scope of the inventive concepts but cover all changes and modifications that can be caused due to a change in manufacturing process. Thus, regions shown in the drawings are illustrated in schematic form and the shapes of the regions are presented simply by way of illustration and not as a limitation. Hereinafter, a slurry composition for polishing in accordance with example embodiments will be described.

The slurry composition for polishing in accordance with example embodiments may include an abrasive agent, an oxidizing agent, and/or a first adsorption inhibitor.

The slurry composition for polishing in accordance with example embodiments may be used to polish a phase change material layer in a phase change memory device. In example embodiments, the phase change material layer may be formed of a phase change material, e.g., a chalcogenide compound. The chalcogenide compound may include tellurium (Te), selenium (Se), sulfur (S), a mixture thereof, or an alloy thereof. For example, the chalcogenide compound may be germanium-antimony-tellurium (Ge—Sb—Te, GST), germanium-selenium-tellurium (Ge—Se—Te), tin-selenium-tellurium (Sn—Se—Te), tin-antimony-tellurium (Sn—Sb—Te), tin-arsenic-selenium (Sn—As—Se), arsenic-germanium-antimony-tellurium (As—Ge—Sb—Te), arsenic-germanium-selenium-tellurium (As—Ge—Se—Te), and germanium-antimony-selenium-tellurium (Ge—Sb—Se—Te), but example embodiments are not limited thereto. Further, in example embodiments, the phase change material layer may be formed of a non-chalcogenide compound including germanium-antimony (Ge—Sb). Hereinafter, a case where a phase change material layer is formed of GST and is polished using a slurry composition for polishing in accordance with example embodiments will be described. However, example embodiments are not limited thereto, and the slurry composition for polishing according to example embodiments may also be applied to a case where the phase change material layer is formed of a material other than GST.

The abrasive agent polishes the phase change material layer. Specifically, the abrasive agent may be selected from silica, alumina, ceria, zirconia and titania, or a mixture thereof, but example embodiments are not limited thereto. The silica may be, e.g., colloidal silica, and/or fumed silica, but example embodiments are not limited thereto. The abrasive agent may have a mean diameter of about 10 nm to 200 nm, for example, about 30 to 100 nm. In a case where the abrasive agent has a mean diameter of about 10 nm to 200 nm, polishing the phase change material layer at a higher speed and achieving a higher flatness after polishing may be possible.

The oxidizing agent may improve a removal rate. For example, the oxidizing agent may be formed of a material selected from hydrogen peroxide (H₂O₂), potassium iodate (KIO₃), percarbonate, benzoyl peroxide, peracetic acid, di-t-butyl peroxide, monopersulfate, perboric acid, periodic acid, perbromic acid, perchloric acid, sodium peroxide and perborate salt, or a mixture thereof, but example embodiments are not limited thereto. The oxidizing agent may be present in an amount of 0.5 to 1.5 parts by weight (wt %) with respect to the composition.

In a case where the oxidizing agent is present in an amount of 0.5 to 1.5 parts by weight with respect to the composition, the removal rate may be improved and a polishing selectivity of a phase change material layer to an insulating film may be higher. Because the phase change material layer is formed on the insulating film while filling a trench formed in the insulating film, as the polishing selectivity with respect to the insulating film is higher, polishing only the phase change material layer at a desired thickness without causing damage to the insulating film in a polishing process may be possible.

The first adsorption inhibitor prevents or inhibits the polished phase change material from being re-adsorbed onto the phase change material layer in the polishing process of the phase change material layer. In a case where the polished phase change material is re-adsorbed onto the phase change material layer, the flatness may be reduced and a scratch and/or defect may occur on the phase change material. In the slurry composition for polishing in accordance with example embodiments, the first adsorption inhibitor may prevent or inhibit other particles from remaining on the phase change material layer, thereby improving the flatness of the phase change material layer.

The first adsorption inhibitor may be a polyethylene oxide copolymer or polypropylene copolymer. For example, the first adsorption inhibitor may be a polyethylene oxide copolymer having a relatively high affinity for a phase change material, e.g., GST. For example, the first adsorption inhibitor may be a copolymer having repeated units of ethylene oxide and propylene oxide, and may be a copolymer represented by Formula 1:

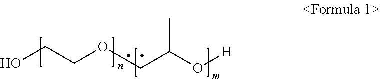

wherein n is an integer ranging from 1 to 500, and m is an integer ranging from 1 to 300.

The copolymer represented by Formula 1 is adsorbed onto the surface of the phase change material layer in the polishing process of the phase change material layer. A hydroxyl group serving as a functional group included in the copolymer may be exposed to the outside. Accordingly, the polished phase change material is prevented or inhibited from being re-adsorbed onto the phase change material layer.

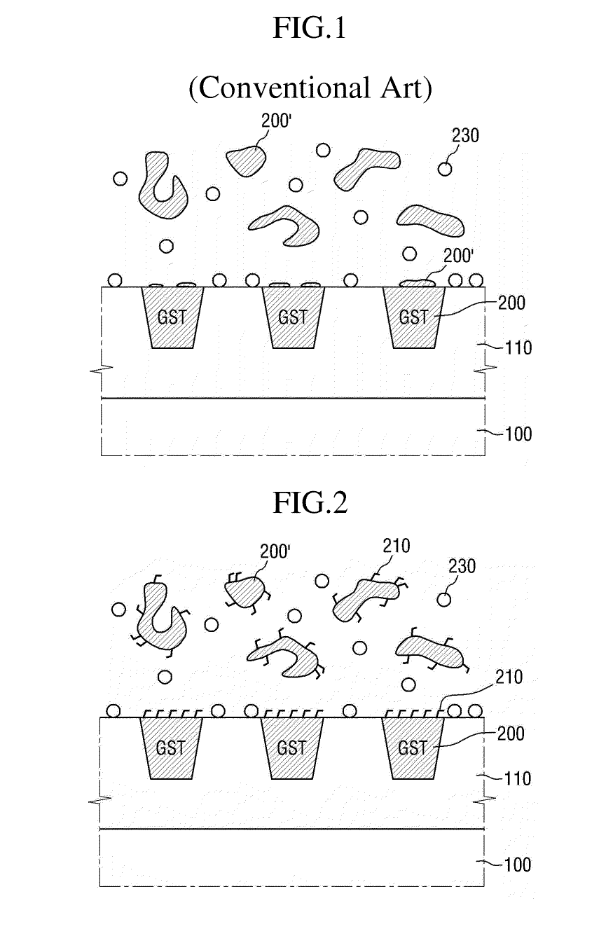

Hereinafter, an interaction between the first adsorption inhibitor and the phase change material will be described in detail with reference to FIGS. 1 and 2. FIG. 1 schematically shows an interaction between the slurry composition for polishing and the phase change material when there is no adsorption inhibitor. FIG. 2 schematically shows an interaction between the phase change material and the first adsorption inhibitor included in the slurry composition for polishing in accordance with example embodiments. FIGS. 1 and 2 illustrate a case where an insulating film 110 is formed on a substrate 100 and a phase change material layer 200 is formed of GST in the insulating film 110. Referring to FIG. 1, in a case where the phase change material layer 200 is polished using a slurry composition for polishing including no adsorption inhibitor, an abrasive agent 230, a polished phase change material 200′ or other particles may be re-adsorbed onto the surface of the phase change material layer 200. Accordingly, the flatness of the phase change material layer 200 may be reduced and the re-adsorbed polished phase change material 200′ may disturb the operation of the phase change memory device. Further, while the polished phase change material 200′ is re-adsorbed onto the surface of the phase change material layer 200, a scratch on the surface of the phase change material layer 200, and a defect on the phase change material layer 200 may occur, thereby reducing a performance of the phase change memory device.

On the other hand, referring to FIG. 2, the first adsorption inhibitor 210 of the slurry composition for polishing in accordance with example embodiments has a relatively high affinity for a phase change material, for example, GST, and thus is adsorbed onto the phase change material layer 200 before the polished phase change material 200′ is re-adsorbed onto the phase change material layer 200. Accordingly, the polished phase change material 200′ or remaining particles are prevented or inhibited from being re-adsorbed onto the phase change material layer 200. Further, the first adsorption inhibitor 210 also combines with the polished phase change material 200′ to prevent or inhibit the polished phase change material 200′ from re-combining with the phase change material layer 200. Accordingly, the flatness of the phase change material layer 200 can be improved after the polishing process, and suppressing occurrence of a scratch and/or defect on the phase change material layer 200 may be possible.

The first adsorption inhibitor 210 may be present in an amount of 0.001 to 0.01 parts by weight with respect to the composition. In example embodiments, preventing or inhibiting the polished phase change material from being re-adsorbed onto the phase change material layer may be possible, thereby increasing the flatness of the phase change material layer. Also, the removal rate may not be reduced without aggregation of the slurry.

In the slurry composition for polishing in accordance with example embodiments, the polishing selectivity with respect to the insulating film may be 1:7.0 or more. Because the slurry composition has such polishing selectivity, only the phase change material layer may be largely polished compared to the insulating film in the polishing process, thereby forming the phase change material layer having a desired shape.

The slurry composition for polishing in accordance with example embodiments may further include an organic acid and/or a solvent in addition to the abrasive agent, the oxidizing agent and the first adsorption inhibitor. The organic acid serves to improve the removal rate due to the abrasive agent and stabilize the oxidizing agent. The organic acid may be a material selected from citric acid, acetic acid, glutaric acid, formic acid, malic acid, maleic acid, oxalic acid, phthalic acid, succinic acid, lactic acid and tartaric acid, or a mixture thereof, but example embodiments are not limited thereto.

The abrasive agent, the oxidizing agent, the first adsorption inhibitor, and/or the organic acid may be distributed in a water-soluble solvent. For example, deionized water and/or lower alcohol may be used as the solvent, but example embodiments are not limited thereto. The content of the solvent may be adjusted by those skilled in the art in consideration of the concentration of the abrasive agent, the oxidizing agent, and/or the first adsorption inhibitor. Further, the slurry composition for polishing may further include other additives, e.g., pH adjuster and/or viscosity controlling agent, if necessary without deviating from the purpose of example embodiments. The pH adjuster may be used to adjust a pH of the slurry composition for polishing in accordance with example embodiments. The pH adjuster may be an inorganic acid, e.g., nitric acid, sulfuric acid, and/or hydrochloric acid or an organic acid, e.g., acetic acid, but example embodiments are not limited thereto.

Hereinafter, a slurry composition for polishing in accordance with example embodiments will be described. The slurry composition for polishing may be different from the slurry composition described above in that a second adsorption inhibitor is included. Accordingly, the description will be given focusing on the difference and a detailed description of substantially the same components as those previously described will be omitted.

The slurry composition for polishing in accordance with example embodiments further includes the second adsorption inhibitor. The second adsorption inhibitor combines with the first adsorption inhibitor to prevent or inhibit the polished phase change material from being re-adsorbed onto the phase change material layer, and also, serves to protect the surface of the phase change material layer.

The second adsorption inhibitor may be an anionic surfactant capable of combining with the first adsorption inhibitor. For example, the second adsorption inhibitor may be an anionic surfactant including a carboxyl group capable of combining with the first adsorption inhibitor. For example, the second adsorption inhibitor may be a material selected from polyacrylic acid, polymethacrylic acid, ammonium polymethacrylate, sodium dodecyl sulfate, polycarboxylate, and alkyl benzene sulfonate, or a mixture thereof. The second adsorption inhibitor may be, e.g., polyacrylic acid represented by Formula 2:

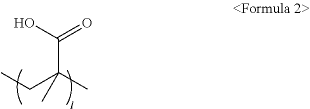

wherein 1 is an integer ranging from 5000 to 500,000.

The polyacrylic acid forms a complex with the first adsorption inhibitor, e.g., polyethylene-polypropylene glycol, to thereby prevent or inhibit the polished phase change material from being re-adsorbed onto the phase change material layer.

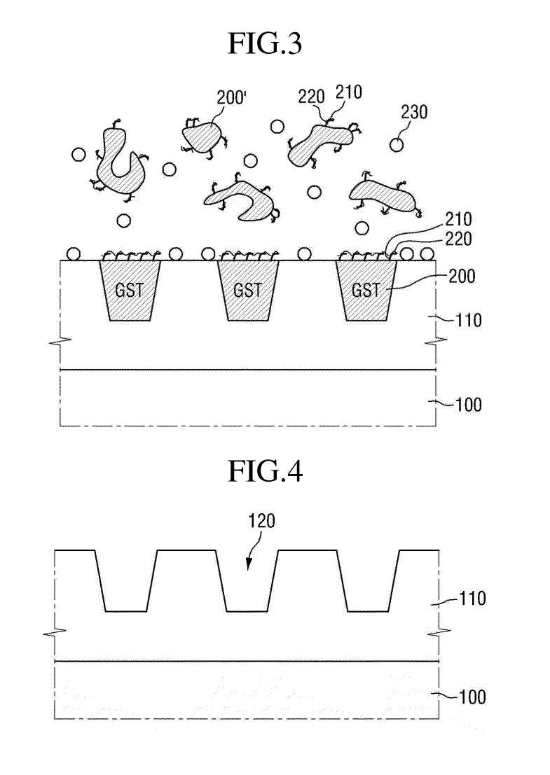

Hereinafter, an interaction between the first and second adsorption inhibitors and the phase change material will be described in detail with reference to FIG. 3. FIG. 3 schematically shows an interaction between the first and second adsorption inhibitors and the phase change material included in the slurry composition for polishing in accordance with example embodiments. FIG. 3 illustrates a case where the first adsorption inhibitor is polyethylene-polypropylene glycol represented by Formula 1 and the second adsorption inhibitor is polyacrylic acid. In a polishing process of the phase change material layer 200, the first adsorption inhibitor 210 has a higher affinity for GST forming the phase change material layer 200 and is adsorbed onto the surface of the phase change material layer 200.

In example embodiments, the hydroxyl group of the first adsorption inhibitor 210 is exposed. The second adsorption inhibitor 220 forms a complex with the first adsorption inhibitor 210 to cover the surface of the phase change material layer 200. For example, the carboxyl group of the second adsorption inhibitor 220 combines with the hydroxyl group of the first adsorption inhibitor 210 so that the second adsorption inhibitor 220 and the first adsorption inhibitor 210 form a complex.

Accordingly, preventing or inhibiting the polished phase change material 200′ from being re-adsorbed onto the phase change material layer 200, and also, protecting the surface of the phase change material layer 200, may be possible. Further, the first adsorption inhibitor 210 also combines with the surface of the polished phase change material 200′ and the second adsorption inhibitor 220 combines with the first adsorption inhibitor 210, thereby preventing or inhibiting the polished phase change material 200′ from being re-adsorbed onto the phase change material layer 200.

The second adsorption inhibitor may be a present in an amount of 0.01 to 1.0 parts by weight with respect to the composition. The second adsorption inhibitor can more smoothly combine with the first adsorption inhibitor. Further, obtaining a film with a higher flatness after the polishing process may be possible, and also, the removal rate may not be reduced without aggregation of the slurry. Further, a weight ratio of the first adsorption inhibitor to the second adsorption inhibitor may range from 1:10 to 1:1000. The first adsorption inhibitor may combine with the second adsorption inhibitor, thereby protecting the surface of the phase change material layer and effectively preventing or inhibiting a defect from occurring on the phase change material layer.

The molecular weight of the second adsorption inhibitor may be greater than the molecular weight of the first adsorption inhibitor. In case of using the second adsorption inhibitor having a molecular weight greater than that of the first adsorption inhibitor, protecting the surface of the phase change material layer may be advantageous. The first adsorption inhibitor may be combined with the phase change material layer, and the second adsorption inhibitor having a molecular weight greater than that of the first adsorption inhibitor may form a complex with the first adsorption inhibitor to cover the entire surface of the phase change material layer, thereby preventing or inhibiting the polished phase change material from being re-adsorbed onto the phase change material layer.

The slurry composition for polishing in accordance with example embodiments may be acidic, and specifically may have a pH of 4 to 7. In a case where the slurry composition for polishing in accordance with example embodiments has a pH of 4 to 7, the removal rate of the phase change material layer may be increased, and complexation between the first adsorption inhibitor and the second adsorption inhibitor may be promoted. Accordingly, preventing or inhibiting the polished phase change material from being re-adsorbed onto the phase change material layer may be possible.

As described above, the slurry composition for polishing in accordance with example embodiments prevents or inhibits the polished material or remaining particles from being re-adsorbed onto a layer generated by polishing, thereby obtaining a film having a relatively high flatness and improved film characteristics after the polishing process.

Hereinafter, a method of manufacturing a phase change memory device in accordance with example embodiments will be described with reference to FIGS. 4 to 6. FIGS. 4 to 6 are cross-sectional views showing intermediate structures for explaining a method of manufacturing a phase change memory device in accordance with example embodiments. The method of manufacturing a phase change memory device in accordance with example embodiments uses the slurry composition for polishing in accordance with the above-described example embodiments in a polishing process.

Referring to FIG. 4, the interlayer insulating film 110 may be formed on the substrate 100 and a trench 120 may be formed in the interlayer insulating film 110. For example, the interlayer insulating film 110 may be deposited on the substrate 100 by using a method, e.g., chemical vapor deposition (CVD), plasma enhanced CVD (PECVD), physical vapor deposition (PVD) and atomic layer deposition (ALD). Subsequently, a mask pattern defining a trench formation region is formed on the interlayer insulating film 110, and the interlayer insulating film 110 is etched. The mask pattern may be removed so that the trench 120 is formed in the interlayer insulating film 110.

The substrate 100 may be a rigid substrate, e.g., a silicon substrate, silicon on insulator (SOI) substrate, gallium arsenic substrate, silicon germanium substrate, ceramic substrate, quartz substrate, and/or glass substrate for display, or a flexible plastic substrate, e.g., polyethyleneterephthalate, polymethylmethacrylate, polyimide, polycarbonate, polyethersulfone, and/or polyethylenenaphthalate. Further, although not shown in the drawing, a conductive film pattern, an insulating film pattern, a pad, an electrode, a gate structure, and/or a structure including a transistor may be formed on the substrate 100.

The interlayer insulating film 110 may be formed of silicon oxide, silicon nitride, and/or silicon oxynitride, but example embodiments are not limited thereto. The silicon oxide may be, e.g., flowable oxide (FOX), tonen silazene (TOSZ), undoped silicate glass (USG), boro silicate glass (BSG), phospho silicate glass (PSG), borophospho silicate glass (BPSG), plasma enhanced tetra ethyl ortho silicate (PE-TEOS), fluoride silicate glass (FSG), and/or high density plasma chemical vapor deposition (HDP-CVD) oxide, but example embodiments are not limited thereto.

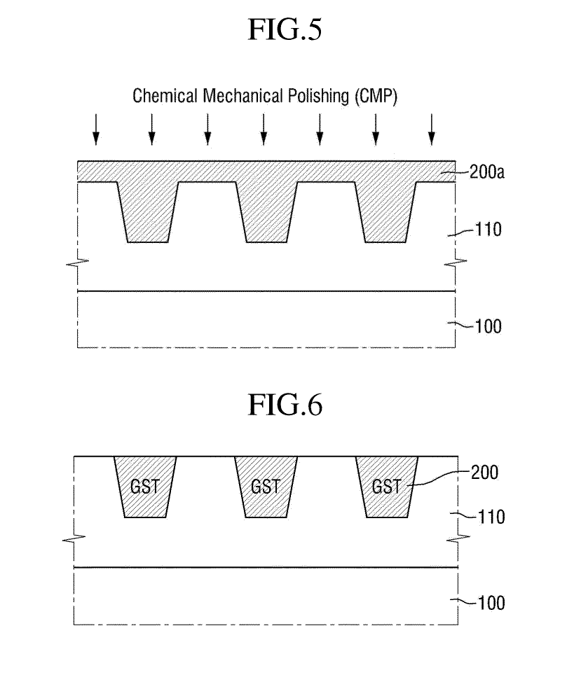

Subsequently, referring to FIG. 5, a phase change material layer 200a is formed on the interlayer insulating film 110 to fill the trenches 120. For example, the phase change material layer 200a is formed by a method, e.g., CVD, PVD and/or ALD, to fill the trenches 120 and cover the entire surface of the interlayer insulating film 110. In example embodiments, the upper surface of the phase change material layer 200a may be formed to have a higher level than the upper surface of the interlayer insulating film 110.

The phase change material layer 200a may be formed of GaSb, InSb, InSe, SbTe, GeTe with two atoms joined; GeSbTe, GaSeTe, InSbTe, SnSb₂Te₄, InSbGe with three atoms joined; AgInSbTe, (GeSn)SbTe, GeSb(SeTe), Te₈₁Ge₁₅Sb₂S₂ with four atoms joined; or these compounds doped with carbon, nitrogen, and/or stabilized metal. For example, the phase change material layer 200a may be formed of GeSbTe (GST) including germanium (Ge), antimony (Sb) and tellurium (Te), and/or GeSbTe doped with carbon (C) or nitrogen (N). The stabilized metal may be, e.g., titanium (Ti), nickel (Ni), zirconium (Zr), molybdenum (Mo), ruthenium (Ru), palladium (Pd), hafnium (Hf), tantalum (Ta), iridium (Ir), and/or platinum (Pt), but example embodiments are not limited thereto.

Referring to FIGS. 5 and 6, a polishing process may be performed on the phase change material layer 200a to form a phase change material pattern layer 200. For example, chemical mechanical polishing (CMP) may be performed on the phase change material layer 200a by using the slurry composition for polishing in accordance with example embodiments, thereby forming the phase change material pattern layer 200.

The phase change material layer 200a may be polished until the interlayer insulating film 110 is exposed, e.g., until the upper surface of the phase change material layer 200a has a level equal to or lower than the upper surface of the interlayer insulating film 110. Accordingly, the phase change material pattern layer 200 filling the trench 120 is formed. In example embodiments, because polishing is performed using the slurry composition for polishing in accordance with example embodiments, the polished phase change material is not re-adsorbed onto the phase change material pattern layer 200. Consequently, obtaining the phase change material pattern layer 200 having a relatively high flatness may be possible and also to prevent or inhibit a defect, e.g., a scratch, from occurring on the surface of the phase change material pattern layer 200. Further, because the slurry composition for polishing in accordance with example embodiments has a polishing selectivity of the phase change material layer to the insulating film, the interlayer insulating film 110 is not excessively polished and an undesired trench is not formed in the interlayer insulating film 110.

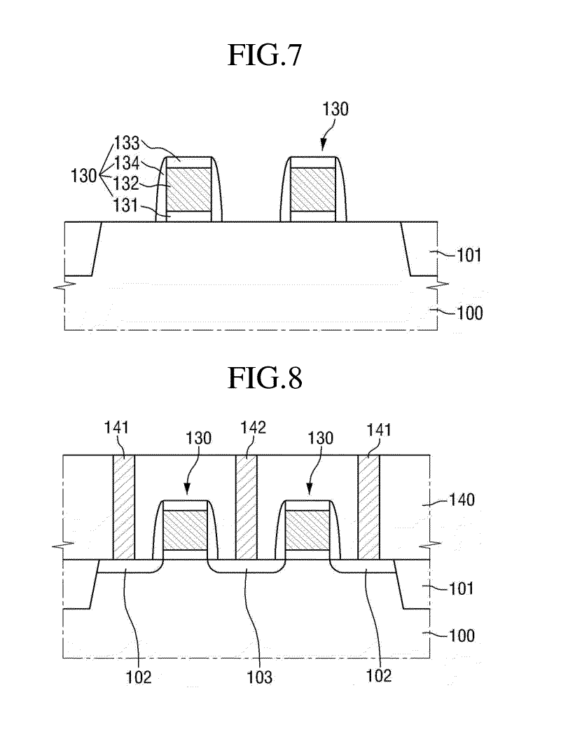

Hereinafter, a method of manufacturing a phase change memory device in accordance with example embodiments will be described with reference to FIGS. 7 to 15. FIGS. 7 to 15 are cross-sectional views showing intermediate structures for explaining a method of manufacturing a phase change memory device in accordance with example embodiments.

Referring to FIG. 7, a gate structure 130 may be formed on the substrate 100. For example, an insulating film for gate insulating film, a conductive film for gate electrode, and an insulating film for hard mask may be sequentially stacked on the substrate 100 on which a device isolation film 101 is formed. Then, a mask pattern defining a gate structure formation region may be formed on the insulating film for hard mask. Then, the insulating film for gate insulating film, the conductive film for gate electrode, and the insulating film for hard mask may be etched and the mask pattern may be removed to thereby form a gate pattern. Subsequently, a gate spacer 134 may be formed on the sidewall of the gate pattern to form the gate structure 130 including a gate insulating film 131, a gate electrode 132, a hard mask 133 and the gate spacer 134.

Referring to FIG. 8, a first conductive region 102 and a second conductive region 103 may be formed in the substrate 100, and a first contact 141 and a second contact 142 may be formed to be electrically connected to the first conductive region 102 and the second conductive region 103. For example, impurities may be injected into the substrate 100 using the gate structure 130 as a mask to from the first conductive region 102 and the second conductive region 103. Subsequently, a first interlayer insulating film 140 may be formed to cover the gate structure 130 by a method, e.g., CVD, PVD and/or ALD. A mask pattern defining a first contact and second contact formation region may be formed on the first interlayer insulating film 140.

After etching the first interlayer insulating film 140, the mask pattern may be removed to form a first contact hole and a second contact hole. In example embodiments, the first contact hole may expose a portion of the first conductive region 102, and the second contact hole may expose a portion of the second conductive region 103. Subsequently, a conductive film may be deposited on the first interlayer insulating film 140 to fill the first contact 141 and the second contact 142.

The conductive film may be removed until the first interlayer insulating film 140 is exposed, thereby forming the first contact 141 in contact with the first conductive region 102 and the second contact 142 in contact with the second conductive region 103. The first interlayer insulating film 140 may be formed of silicon oxide, silicon oxynitride, and/or silicon nitride. The conductive film may be formed of tungsten, aluminum, copper, titanium, tantalum, nitride thereof, and/or doped polysilicon, but example embodiments are not limited thereto.

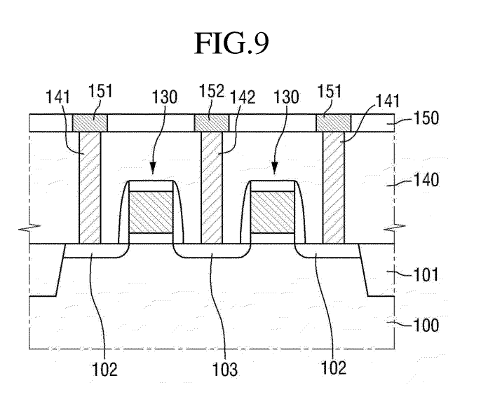

Referring to FIG. 9, a first wiring 151 and a second wiring 152 in contact with the first contact 141 and the second contact 142 may be formed. For example, a second interlayer insulating film 150 may be deposited on the first interlayer insulating film 140 by a method, e.g., CVD, PVD and/or ALD. Subsequently, a mask pattern defining a first wiring and second wiring formation region may be formed on the second interlayer insulating film 150. After etching the second interlayer insulating film 150, the mask pattern may be removed to form a third contact hole exposing the first contact 141 and a fourth contact hole exposing the second contact 142. A conductive film may be formed on the second interlayer insulating film 150 to fill the third contact hole and the fourth contact hole. The conductive film may be removed until the second interlayer insulating film 150 is exposed, thereby forming the first wiring 151 in contact with the first contact 141 and the second wiring 152 in contact with the second contact 142.

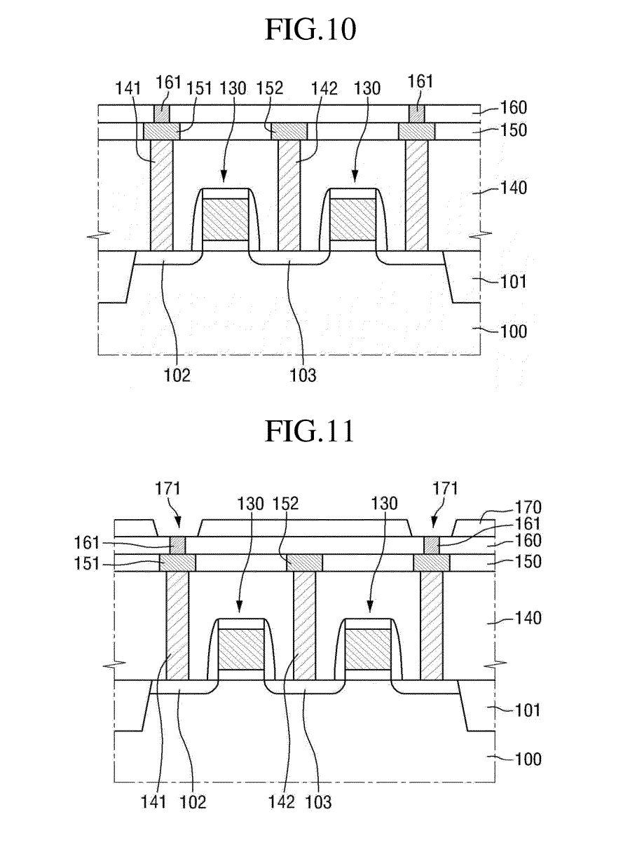

Referring to FIG. 10, a first electrode 161 in contact with the first wiring 151 may be formed on a third interlayer insulating film 160. For example, the third interlayer insulating film 160 may be formed on the second interlayer insulating film 150 by a method, e.g., CVD, PVD and/or ALD. A mask pattern defining a first electrode formation region may be formed on the third interlayer insulating film 160. The third interlayer insulating film 160 may be etched to form a via hole exposing the first wiring 151. Subsequently, a conductive film is deposited on the third interlayer insulating film 160 to fill the via hole, and the conductive film may be removed until the third interlayer insulating film 160 is exposed to form the first electrode 161. The first electrode 161 may be formed of metal, metal nitride, and/or doped polysilicon.

For example, the first electrode 161 may be formed of titanium nitride (TiN), titanium aluminum nitride (TiAlN), tantalum nitride (TaN), tungsten nitride (WN), molybdenum nitride (MoN), niobium nitride (NbN), titanium silicon nitride (TiSiN), titanium boron nitride (TiBN), zirconium silicon nitride (ZrSiN), tungsten silicon nitride (WSiN), tungsten boron nitride (WBN), zirconium aluminum nitride (ZrAlN), molybdenum aluminum nitride (MoAlN), tantalum silicon nitride (TaSiN), tantalum aluminum nitride (TaAlN), titanium tungsten (TiW), titanium aluminum nitride (TiAl), titanium oxynitride (TiON), titanium aluminum oxynitride (TiAlON), tungsten oxynitride (WON), and/or tantalum oxynitride (TaON), but example embodiments are not limited thereto.

Referring to FIG. 11, a fourth interlayer insulating film 170 including a trench 171 may be formed on the third interlayer insulating film 160. For example, the fourth interlayer insulating film 170 may be deposited on the third interlayer insulating film 160 by a method, e.g., CVD, PVD and/or ALD. Then, after a mask pattern defining a trench formation region is formed on the fourth interlayer insulating film 170, the fourth interlayer insulating film 170 may be etched and the mask pattern may be removed to form the trench 171 exposing the first electrode 161.

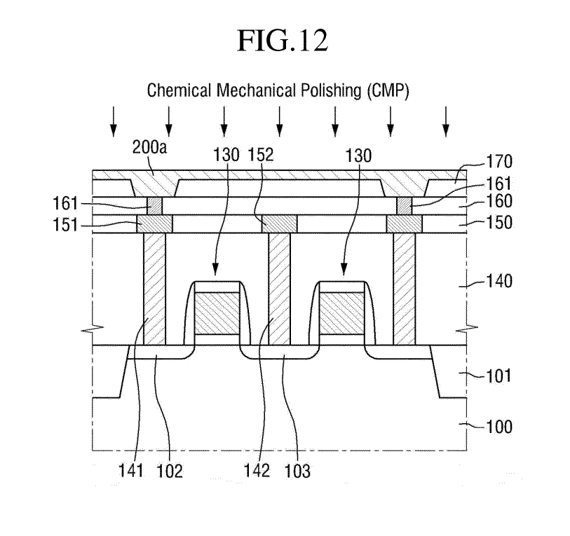

Referring to FIG. 12, the phase change material layer 200a filling the trench 171 may be formed on the fourth interlayer insulating film 170. For example, the phase change material may be deposited on the fourth interlayer insulating film 170 by a method, e.g., CVD, PVD and/or ALD, to form the phase change material layer 200a filling the trench 171. In example embodiments, the phase change material layer 200a may be formed to completely fill the trench 171 and the upper surface of the phase change material layer 200a may be formed to have a higher level than the upper surface of the fourth interlayer insulating film 170. The phase change material layer 200a may be formed of a chalcogenide compound, e.g., GST.

Referring to FIGS. 12 to 14, the phase change material layer 200a may be polished to form the phase change material pattern layer 200. For example, the phase change material layer 200a may be polished by chemical mechanical polishing (CMP) until the fourth interlayer insulating film 170 is exposed to from the phase change material pattern layer 200. The upper surface of the phase change material pattern layer 200 may have a level equal to or lower than the upper surface of the fourth interlayer insulating film 170. Further, the width of the phase change material pattern layer 200 may be larger as it goes from the first electrode 161 toward a second electrode 181 that will be described later. That is, the width of the phase change material pattern layer 200 in contact with the first electrode 161 may be smaller than the width of the phase change material pattern layer 200 in contact with the second electrode 181. FIGS. 12 to 14 illustrate a case where the cross section of the phase change material pattern layer 200 has a trapezoidal shape.

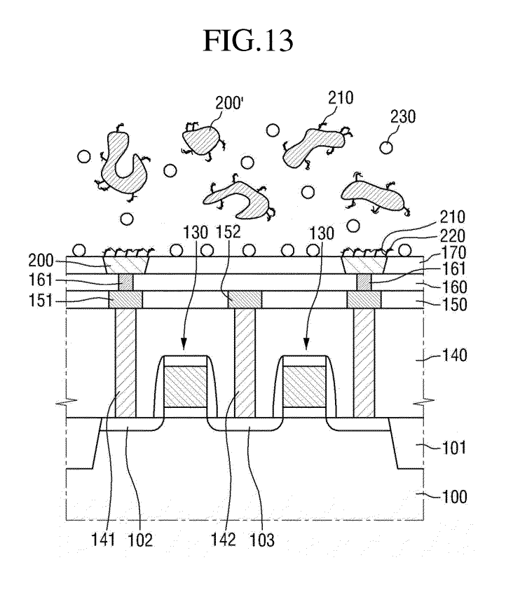

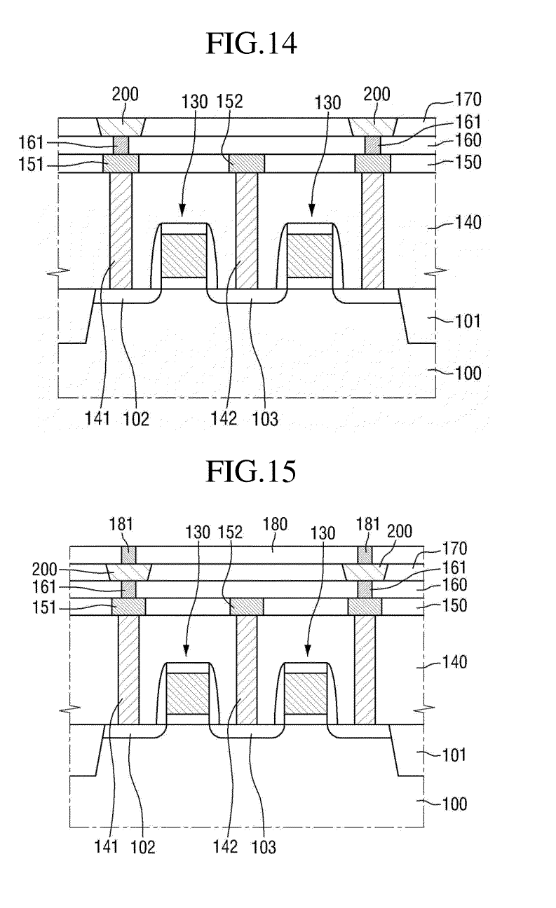

In example embodiments, chemical mechanical polishing is performed by using the slurry composition for polishing. FIG. 13 illustrates a case where the slurry composition for polishing includes the adsorption inhibitor 230, the first adsorption inhibitor 210 and second adsorption inhibitor 220, but in some example embodiments, it may not include the second adsorption inhibitor 220. As illustrated in FIG. 13, the first adsorption inhibitor 210 and the second adsorption inhibitor 220 combine with the surface of the phase change material pattern layer 200 to prevent or inhibit the polished phase change material 200′ from being re-adsorbed to the surface of the phase change material pattern layer 200, and also to protect the surface of the phase change material pattern layer 200. Further, the slurry composition for polishing in accordance with example embodiments has a higher polishing selectivity with respect to the insulating film to thereby form the phase change material pattern layer 200 as illustrated in FIG. 14 with an improved flatness without excessively polishing the fourth interlayer insulating film 170.

Referring to FIG. 15, the second electrode 181 electrically connected to the phase change material layer 200 may be formed. For example, the insulating film may be deposited on the fourth interlayer insulating film 170 and the phase change material pattern layer 200 by a method, e.g., CVD, PVD and/or ALD, to form a fifth interlayer insulating film 180. After a mask pattern defining a second electrode formation region is formed on the fifth interlayer insulating film 180, the fifth interlayer insulating film 180 may be etched to form a via hole exposing the phase change material pattern layer 200. Subsequently, a conductive film may be formed on the fifth interlayer insulating film 180 to fill the via hole, and then an etch back and/or chemical mechanical polishing process may be performed to form the second electrode 181 in contact with the phase change material pattern layer 200. The second electrode 181 may be formed of the same material as that of the first wiring 151, but example embodiments are not limited thereto.

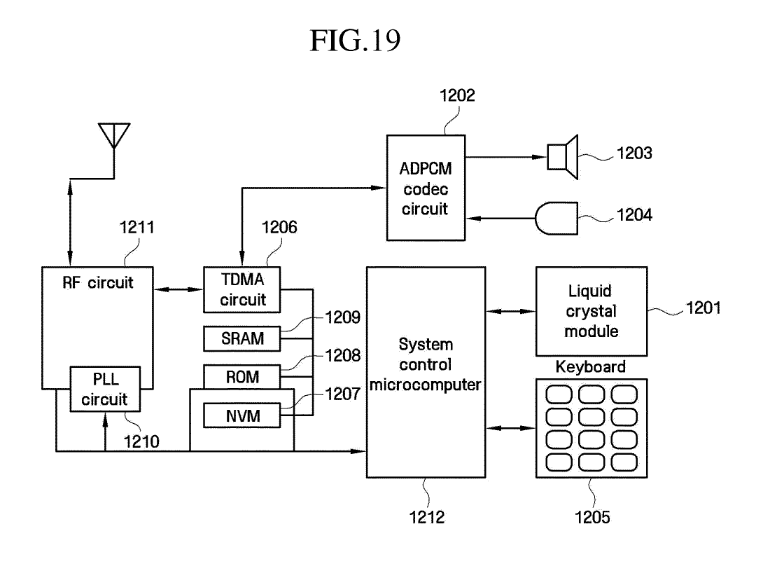

Hereinafter, systems using a phase change memory device manufactured in accordance with example embodiments will be described. FIGS. 19 to 23 are diagrams for explaining systems using a phase change memory device manufactured by the method in accordance with example embodiments.

FIG. 19 is a diagram of a cellular phone system using a phase change memory device manufactured in accordance with example embodiments. Referring to FIG. 19, the cellular phone system may include a liquid crystal module 1201, a keyboard 1205, an ADPCM codec circuit 1202 which compresses the sound or decompresses the compressed sound, a speaker 1203, a microphone 204, a TDMA circuit 1206 which time-division multiplexes digital data, a PLL circuit 1210 which sets a carrier frequency of a wireless signal, and/or a RF circuit 1211 which transmits or receives a wireless signal.

Further, the cellular phone system may include various types of memory devices, e.g., a phase change memory device 1207, a ROM 1208, and a SRAM 1209. The phase change memory device 1207 may be a phase change memory device manufactured in accordance with example embodiments, which may store, e.g., an ID number. The ROM 1208 may store a program and the SRAM 1209 may serve as an operation region for a system control microcomputer 1212, or temporarily store data. In example embodiments, the system control microcomputer 1212 may serve as a processor to control a write operation and read operation of the phase change memory device 1207.

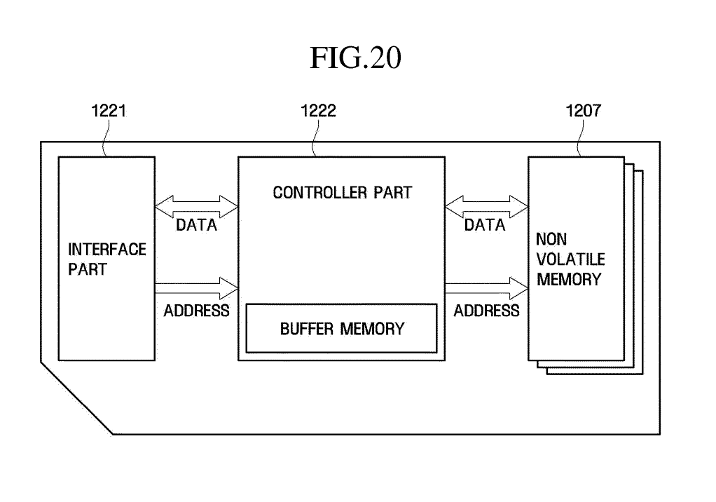

FIG. 20 is a diagram of a memory card using a phase change memory device manufactured in accordance with example embodiments. The memory card may be, e.g., a MMC card, SD card, multiuse card, micro SD card, memory stick, compact SD card, ID card, PCMCIA card, SSD card, chipcard, smartcard, and/or USB card.

Referring to FIG. 20, the memory card may include an interface part 1221 which interfaces with the external environment, a controller 1222 which has a buffer memory and controls the operation of the memory card, and at least one phase change memory device 1207 manufactured in accordance with example embodiments. The controller 1222 may serve as a processor to control a write operation and read operation of the phase change memory device 1207. For example, the controller 1222 may be coupled with the phase change memory device 1207 and the interface part 1221 via a data bus DATA and an address bus ADDRESS.

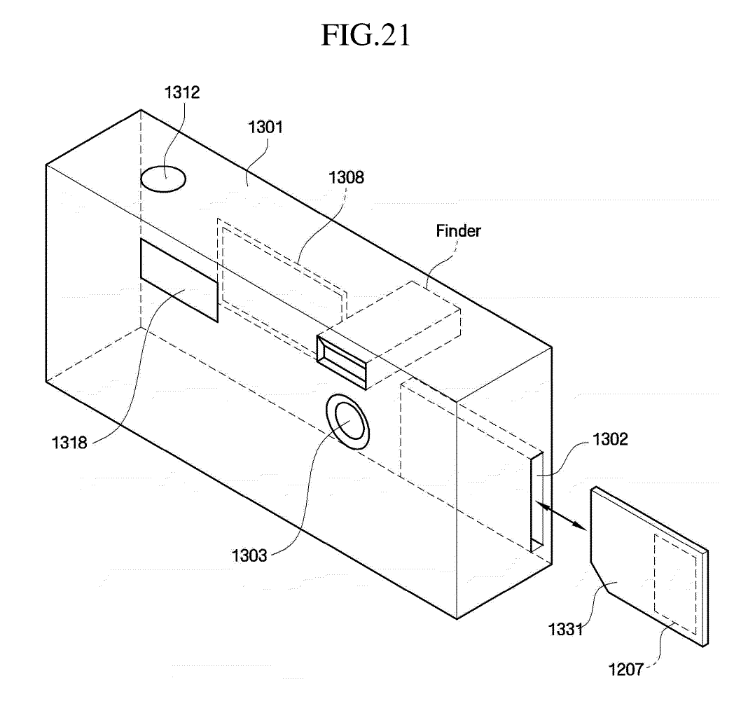

FIG. 21 is a diagram of a digital still camera using a phase change memory device manufactured in accordance with example embodiments. Referring to FIG. 21, the digital still camera includes a body 1301, a slot 1302, a lens 1303, a display unit 1308, a shutter button 1312, and/or a strobe 1318. Particularly, a memory card 1331 may be inserted into the slot 1302 and the memory card 1331 may include at least one phase change memory device 1207 manufactured in accordance with example embodiments. In a case where the memory card 1331 is a contact type card, when the memory card 1331 is inserted into the slot 1302, the memory card 1331 may come into electrical contact with a specific electric circuit on a circuit board. In a case where the memory card 1331 is a non-contact type card, the memory card 1331 performs communication with a specific electric circuit on a circuit board through a wireless signal.

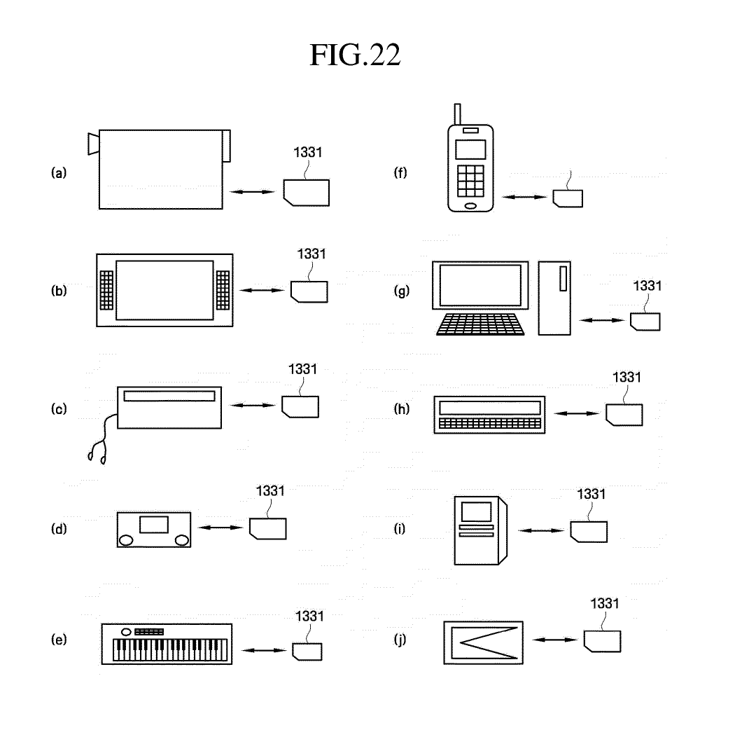

FIG. 22 is a diagram for explaining various systems using the memory card of FIG. 20. Referring to FIG. 22, a memory card 1331 may be used for (a) video camera, (b) television, (c) audio device, (d) game device, (e) electronic music device, (f) cellular phone, (g) computer, (h) personal digital assistant (PDA), (i) voice recorder, and/or (j) PC card.

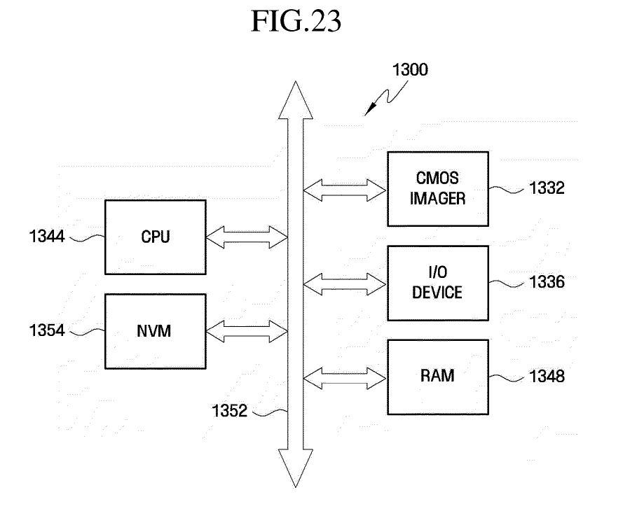

FIG. 23 is a diagram of an image sensor system using a phase change memory device manufactured in accordance with example embodiments. Referring to FIG. 23, the image sensor system may include an image sensor 1332, an input/output device 1336, a RAM 1348, a CPU 1344, and/or a phase change memory device 1354 manufactured in accordance with example embodiments. The respective components, e.g., the image sensor 1332, the input/output device 1336, the RAM 1348, the CPU 1344, and the phase change memory device 1354, may perform communication with each other via a bus 1352. The image sensor 1332 may include a photo sensing element, e.g., photogate and photodiode. The respective components may be configured as one chip with a processor, or configured as a chip separated from a processor.

Hereinafter, the slurry composition for polishing in accordance with example embodiments and the phase change memory device manufactured using the slurry composition will be described in detail through experimental examples.

### EXPERIMENTAL EXAMPLE 1

### Evaluation on Complexation Between First Adsorption Inhibitor and Second Adsorption Inhibitor

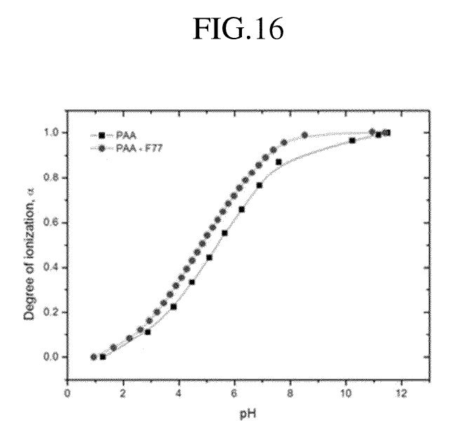

In a case where polyethylene-polypropylene glycol is used as the first adsorption inhibitor and polyacrylic acid is used as the second adsorption inhibitor, degree of ionization cc was measured to observe whether there is complexation between them. The result thereof is shown in FIG. 16.

A carboxyl group of the polyacrylic acid is ionized into COO— and H+. In a case where polyethylene-polypropylene glycol is present, the COO— forms a hydrogen bond with H of polyethylene-polypropylene glycol. Accordingly, the carboxyl group of the polyacrylic acid is ionized more quickly. Referring to FIG. 16, in a case where the polyacrylic acid is present with polyethylene-polypropylene glycol as compared to a case where the polyacrylic acid is solely present at the same degree of ionization, COOH was ionized quickly into COO— and H+and a lower pH was achieved. This seems to be because COO— of the polyacrylic acid forms a hydrogen bond with H of polyethylene-polypropylene glycol.

### EXPERIMENTAL EXAMPLE 2

### Evaluation on Removal Rate and Stability of Slurry in Case of Using both First Adsorption Inhibitor and Second Adsorption Inhibitor

In a case where polyacrylic acid is used as the second adsorption inhibitor and various types of materials are used as the first adsorption inhibitor as represented in Table 1 below, the GST removal rate and the slurry stability were measured for comparison. After the slurry composition was prepared by mixing materials represented in Table 1 below with hydrogen peroxide and silica and left at room temperature for about 10 minutes, whether aggregation occurs and sediment is generated and whether phase separation occurs were observed with the naked eye to evaluate slurry stability. The result thereof is shown in Table 1 below.

TABLE 1

| | PAA | | GST | |
|---|---|---|---|---|
| | Content | | Removal rate | |
| | (ppm) | Nonionic surfactant | (Å/min) | Stability |
| 1 | 300 | Polyethylene-polypropylene | 1180 | Stable |
| | | glycol | | |
| 2 | 300 | Nonanoic acid | 905 | Stable |
| 3 | 300 | Zonyl FSE | 1040 | Unstable |
| 4 | 300 | Fluorobenzene | 690 | Unstable |
| 5 | 600 | Polyethylene-polypropylene | 1035 | Stable |
| | | glycol | | |
| 6 | 600 | Nonanoic acid | 820 | Unstable |
| 7 | 600 | Zonyl FSE | 875 | Unstable |
| 8 | 600 | Fluorobenzene | 640 | Unstable |

As represented in Table 1, in a case where polyethylene-polypropylene glycol is used as the first adsorption inhibitor and polyacrylic acid is used as the second adsorption inhibitor, the removal rate and the slurry stability were improved.

### EXPERIMENTAL EXAMPLE 3

### Evaluation on Removal Rate

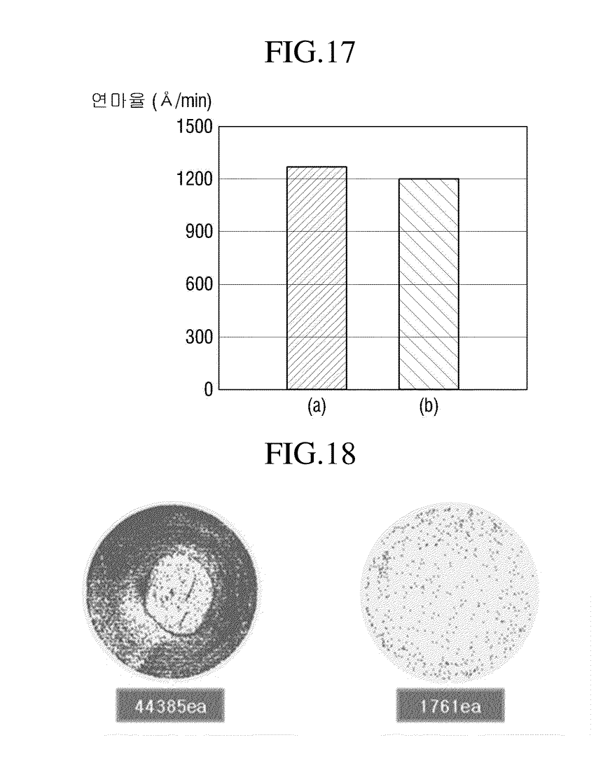

A slurry composition (a) including colloidal silica present in an amount of 0.3 part by weight and hydrogen peroxide present in an amount of 1.0 part by weight and a slurry composition for polishing (b) in accordance with example embodiments including colloidal silica present in an amount of 0.3 part by weight, hydrogen peroxide present in an amount of 1.0 part by weight, polyethylene-polypropylene glycol present in an amount of 0.05 part by weight and polyacrylic acid present in an amount of 0.03 part by weight were prepared. GST was polished using the compositions (a) and (b) and the removal rate was represented in FIG. 17.

### EXPERIMENTAL EXAMPLE 4

### Evaluation on Whether Defect is Reduced

After a phase change material layer formed of GST was polished using the compositions (a) and (b) prepared in Experimental example 3, defects occurring on the phase change material layer were observed and represented in FIG. 18.

Referring to FIG. 18, in case of using the composition (a), 44385 defects were measured and in case of using the composition (b), 1761 defects were generated. That is, the composition in accordance with example embodiments reduces the number of defects occurring on the phase change material layer in a polishing process.

In concluding the detailed description, those skilled in the art will appreciate that many variations and modifications can be made to example embodiments without substantially departing from the principles of the inventive concepts. Therefore, the disclosed example embodiments are used in a generic and descriptive sense only and not for purposes of limitation.

1. A slurry composition for polishing, the slurry composition comprising:
an abrasive agent;
an oxidizing agent; and
a first adsorption inhibitor including a polyethylene oxide copolymer.

2. The slurry composition of claim 1, wherein the first adsorption inhibitor is represented by Formula 1: 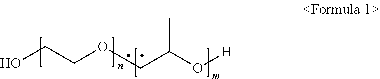
wherein n is an integer ranging from 1 to 500, and m is an integer ranging from 1 to 300.

3. The slurry composition of claim 1, further comprising:
a second adsorption inhibitor including a carboxyl group.

4. The slurry composition of claim 3, wherein a weight ratio of the first adsorption inhibitor to the second adsorption inhibitor ranges from about 1:10 to 1:1000.

5. The slurry composition of claim 3, wherein the second adsorption inhibitor is polyacrylic acid.

6. The slurry composition of claim 5, wherein the second adsorption inhibitor is present in an amount of about 0.01 to 1.0 parts by weight with respect to the composition.

7. A slurry composition for polishing, the slurry composition comprising:
an abrasive agent;
an oxidizing agent;
a first adsorption inhibitor including a copolymer having repeated units of ethylene oxide and propylene oxide; and
a second adsorption inhibitor including an anionic surfactant configured to combine with the first adsorption inhibitor.

8. The slurry composition of claim 7, wherein the second adsorption inhibitor is polyacrylic acid.

9. The slurry composition of claim 7, wherein a molecular weight of the second adsorption inhibitor is greater than a molecular weight of the first adsorption inhibitor.

10. The slurry composition of claim 7, wherein the oxidizing agent is hydrogen peroxide.

11. The slurry composition of claim 10, wherein the oxidizing agent is present in an amount of about 0.5 to 1.5 parts by weight with respect to the composition.

12. The slurry composition of claim 7, wherein the composition has a pH of about 4 to 7.

13. The slurry composition of claim 7, wherein the abrasive agent is selected from one of colloidal silica, ceria, fumed silica and alumina, and a mixture thereof.

14. The slurry composition of claim 7, wherein the slurry composition is configured to perform chemical mechanical polishing on a phase change material layer in a phase change memory device including the phase change material layer.

15. The slurry composition of claim 14, wherein the phase change material layer includes germanium-antimony-tellurium (GeSbTe).

16-17. (canceled)

18. A slurry composition for polishing comprising at least one adsorption inhibitor, the at least one adsorption inhibitor including one of a polyethylene oxide copolymer and polypropylene copolymer.

19. The slurry composition of claim 18, further comprising:
an abrasive agent; and
an oxidizing agent.

20. The slurry composition of claim 18, wherein the first adsorption inhibitor is represented by Formula 1: 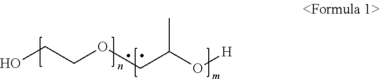
wherein n is an integer ranging from 1 to 500, and m is an integer ranging from 1 to 300.

21. The slurry composition of claim 18, further comprising:
a second adsorption inhibitor including a carboxyl group.

22. The slurry composition of claim 21, wherein a weight ratio of the first adsorption inhibitor to the second adsorption inhibitor ranges from about 1:10 to 1:1000.

23-25. (canceled)
